(19) United States
(12) Patent Application Publication
(10) Pub. No.: US 2010/0301990 A1
(43) Pub. Date: Dec. 2, 2010

(54) APPARTUS AND METHOD FOR AFFECTING CHANGE IN A TARGET USING AN INTEGRATED LIGHTING SYSTEM

(76) Inventors: Christopher Michael Bourget, Fitchburg, WI (US); Robert Morrow, Madison, WI (US); Ronald J. Anderson, Fitchburg, WI (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/787,644

(22) Filed: May 26, 2010

Related U.S. Application Data
(60) Provisional application No. 61/182,384, filed on May 29, 2009.

(51) Int. Cl. G05B 23/02

(52) U.S. Cl. 340/3.1

(57) ABSTRACT

Methods and systems for affecting change in a target using an integrated lighting system are provided. A light source having one or more parameters and being configured to provide lighting is operably connectable to a control system. A sensor configured to detect a lighting condition from a target and/or target environment is also operably connectable to the control system. The control system may adjust the one or more parameters of the light source assembly when the detected lighting condition from the target environment is different from a desired lighting condition. The light source, sensor, and control system may be provided in connection with an enclosed environment.

### CROSS-REFERENCE TO RELATED APPLICATION(S)

The present utility patent application claims priority to U.S. Provisional Patent Application Ser. No. 61/182,384, filed May 29, 2009; subject matter of which is incorporated herewith by reference.

This invention was made with Government support under contract NNK05OA20C awarded by NASA. The Government has certain rights in this invention.

### TECHNICAL FIELD

The present disclosure relates to systems and methods for affecting change in a target, wherein the target is responsive in some respect to light. For example, the target may be a living organism, tissue, or an environment, for example. In particular, the present disclosure relates to systems and methods using an integrated lighting system comprising precision lighting arrays, and associated sensors and controls. In further particularity, the present disclosure relates to systems and methods using low-energy controlled light sources to provide optimal lighting conditions to affect the desired change or outcome in the target. In some embodiments, optimal lighting conditions may be provided for a living organism growth system, and may also allow manipulation in some embodiments of the form and function of the living organism.

### BACKGROUND

Many scientific and industrial applications currently require self-contained living organism growing environments. For example, growing plants that are genetically engineered to produce pharmaceuticals or other desirable organic products in many cases will require containment. Bio molecular farming operations may employ such a system to eliminate comingling or contamination between traditional plants and plants grown to produce bio-engineered products.

A particularly important consideration for the design of such a controlled environment may be the systems and methods used to provide lighting suitable for plant growth, as lighting affects both the energy consumption of the facility and the rate and quality of plant growth. Existing lighting technologies for plant growth, some of which are based on high-intensity discharge (HID) lamps, high pressure sodium lamps, fluorescent lamps, or other gaseous discharge lamps are not desirable for use in a facility dedicated to the efficient growth of living organisms as these types of light sources may convert only 10-30% of electrical energy into light, and only a portion of that light can be used by plants because each species of plant only absorbs light at specific wavelengths.

Furthermore, it is known in the art to modify energy inefficient white light sources, such as HID lamps, to produce more light at wavelengths known to promote plant growth and health. This alternative is undesirable because much of the light from these augmented lamps cannot be used efficiently by plants. Such lamps also generate radiant heat which must be eliminated to prevent damage to the plants they illuminate, thereby increasing the operational cost associated with the use of such lights. Also, often times, such lamps emit short wavelength UV light which can be damaging to both the plants being grown under them and the people tending the plants. Furthermore, such lamps contain environmentally damaging metals and have a short operating life.

Thus, there is a need in the art for low-energy lighting systems and methods which are configurable at specific frequencies or wavelengths so as to provide enhanced control of, for example, plant growth results. There is also a need in the art for systems and methods to analyze the growth and maturity of living organisms, such as plants, to monitor the condition of the organisms and the environment, and to adjust operational parameters to optimize the growth process. Such systems and methods may provide a means to automatically control parameters that impact growth with little or no human intervention, and may include an automated control-feedback method for detecting the status and condition of the organism, in response to the detected growth status and/or the other conditions of the organism, whereby changes in the environmental conditions, such as temperature, light intensity, etc., may be implemented to optimize the growth of the organism and minimize the consumption of energy.

### SUMMARY

In some embodiments, disclosed herein is an apparatus for the growth of a living organism in an environment, comprising a light source assembly including a plurality of LEDs having one or more parameters and being configured to provide lighting, wherein each of the plurality of LEDs is individually integrated in the light source assembly. The apparatus further includes a sensor configured to detect at least one lighting condition from the target and/or the light source, wherein the target is an object, including an organism and one of the lighting conditions detected from the target is whether or not the target is present, and a light control system operably connectable to the light source assembly and the sensor, wherein the light control system can intelligently control the amount and type of light provided to the target by controlling each LED and each sensor individually, and wherein when the sensor detects the lighting condition from the environment and/or light source, the sensor sends a signal (e.g. an electric signal) representing the detected lighting condition to the light control system, wherein upon receiving the signal from the sensor, the light control system compares the detected lighting condition to a desired lighting condition, and wherein if the detected lighting condition is different from the desired lighting condition, the light control system adjusts the one or more parameters of the light source.

In variations of these embodiments, the apparatus further comprises an enclosed environment for an organism.

In other embodiments disclosed herein is a method for affecting change in a target using an integrated lighting system. The method comprises providing a light source assembly including a plurality of LEDs having one or more parameters and being configured to provide lighting; providing a sensor configured to detect at least one lighting condition from the environment and/or the light source assembly, and wherein one of the lighting conditions detected from the target is whether or not the target is present. The method also includes providing a light control system operably connectable to the light source assembly and the sensor, wherein the light control system intelligently controls the amount and type of light provided to the target by controlling each LED and each sensor individually; wherein when the sensor detects the lighting condition from the target and/or the light source assembly, the sensor sends a signal representing the detected lighting condition to the light control system; wherein upon receiving the signal from the sensor, the light control system compares the detected lighting condition to a desired lighting condition; and wherein if the detected lighting condition is different from the desired lighting condition, the light control system adjusts the one or more parameters of the light source.

In variations of these embodiments, the environment is an enclosed growing environment for a living organism.

Further embodiments of the present disclosure may employ High Efficiency Lighting with Integrated Adaptive Control (HELIAC). In these embodiments, automated adaptive controls may allow the lighting system to detect the position of, for example, plant leaves through reflectance of green light, and algorithms may integrate these signals into a lighting pattern that changes automatically in response to plant position and leaf area. Thus, minimum electrical energy and human resources may be used to produce a crop/plant yield.

While multiple embodiments are disclosed, still other embodiments of the present disclosure will become apparent to those skilled in the art from the following detailed description, which show and describe illustrative embodiments of the invention. As will be realized, the embodiments are capable of modifications in various obvious aspects, all without departing from the spirit and scope of the present disclosure. Furthermore, while some embodiment lighting systems are described with respect to their application within a controlled plant growing environment, it will be appreciated that such lighting systems may be implemented independently, or in other environments. Accordingly, the drawings and detailed description are to be regarded as illustrative in nature and not restrictive.

### FIGURES

FIG. 1a depicts a lighting configuration in accordance with one embodiment of the present disclosure.

FIG. 1b depicts a lighting configuration in accordance with an alternate embodiment of the present disclosure.

FIG. 2a depicts a plant growing environment with a lighting arrangement provided therewith in accordance with one embodiment of the present disclosure.

FIG. 2b depicts a plant growing environment with a lighting arrangement provided therewith in accordance with the alternate embodiment of the present disclosure.

FIG. 3a depicts an exemplary apparatus and method for controlled plant growth using precision lighting arrays, associated sensors and controls, in accordance with the principle of the present disclosure.

FIG. 3b depicts a flowchart diagram of a method suitable for use in some embodiments of the present disclosure.

FIG. 4 depicts a flowchart diagram of a method suitable for use in some embodiments of the present disclosure.

FIG. 5 depicts a flowchart diagram of a control process suitable for use in some embodiments of the present disclosure.

### DETAILED DESCRIPTION

The integrated lighting system of the present disclosure may be used to affect and/or control a variety of parameters associated with the subject being exposed to the lighting system. While many of the embodiments disclosed herein are discussed with regard to plants, it will be recognized that the integrated lighting system of the present disclosure may also be used beneficially and advantageously to affect targets other than plants. Embodiments of the present disclosure may be used to, for example, but are not limited to, grow bacteria, culture tissue, or produce algae, etc.

In fact, any organism or process that may be affected by exposure to a controllable integrated lighting system may benefit from embodiments of the present disclosure. For example, the integrated lighting system of the present disclosure may be used in human research and/or therapy. It is understood, for example, that mammalian sleep cycles may be affected both positively and negatively by light. Accordingly, embodiments of the present invention may be used to affect, alter, or change the sleep patterns of humans and/or animals.

Further, the integrated lighting system of the present disclosure may be used in animal research, husbandry, or production. For example, it is known that chickens may respond to a photoperiod cycle for egg laying. Embodiments of the present invention may be used to control, affect or change the photoperiod cycle, for example.

Still in other embodiments, the integrated lighting system of the present disclosure may be used in human living and/or working areas to control the amount of light present. For example, in some embodiments, the integrated lighting system of the present disclosure may be used to detect if a person or people are in a room. If the system does not detect the presence of a person, the light(s) may automatically turn off, for example. Alternately, the lighting apparatus and system of the present disclosure may be used to set a desired lighting level, whereby in such an embodiment, the amount of external light may be measured and the lighting system and method may be used to provide the amount of light between the desired amount of light and the amount of light provided by the external source or sources. While the above embodiments are described in some detail, it will be recognized that the invention of the present disclosure is not limited to such embodiments.

Provided in some embodiments of the present disclosure are a plurality of light sources configured in a light source assembly. Light sources may comprise, for example, light emitting diodes (LEDs), fluorescent lamps, or any other type of lighting apparatus, the parameters of which may be substantially controlled by a light control system, whereby a user may use the light control system to set and/or change one or all parameters, or the parameters may be set and/or changed automatically by the light control system. Parameters may include, for example, wavelength, output intensity, and other lighting parameters as will be known to those skilled in the art. The plurality of light sources may also comprise a combination of one or more different types of light sources.

Some embodiments of the present disclosure may employ LEDs as some or all of the plurality of light sources in the light source assembly. In these embodiments, methods and apparatuses in accordance with the present disclosure may be especially suited to achieve the objectives of low energy use, precise controllability, and enhanced, or alternately inhibited, growth of living organisms, among others. LEDs may present many advantages over traditional light sources including lower energy consumption, longer lifetime, improved robustness, smaller size, and faster repair or replacement.

With regard to energy use, one advantage of LED-based lighting may be its high efficiency, as measured by its light output per unit power input. For example, existing LEDs may produce a luminous efficacy of approximately 18-22 lumens per watt (lm/W). In comparison, a conventional 60-100 W incandescent light bulb generally produces around 15 lm/W.

With regard to longevity, solid state devices such as LEDs may be subject to very limited wear and tear if operated at low currents and at low temperatures. A typical lifetime for an LED may be 25,000 to 100,000 hours, whereas the lifetime for conventional lighting systems may be substantially less, and in some cases may be orders of magnitude less.

With regard to controllability, commercially available LEDs are available in numerous wavelength ranges (colors). These LEDs may include, for example, and in general, infrared (λ>760), red (610<λ<760), orange (590<λ<610), yellow (570<λ<590), green (500<λ<570), blue (450<λ<500), violet (400<λ<450), ultraviolet (λ<400), and white (many), and wavelengths in between. Thus, individual or appropriate combinations of LEDs may be precisely controlled so as to provide ranges/wavelengths especially adapted to produce a desired result in a target. It is also appreciated that combinations of other appropriate light sources may be used within the scope of the present invention.

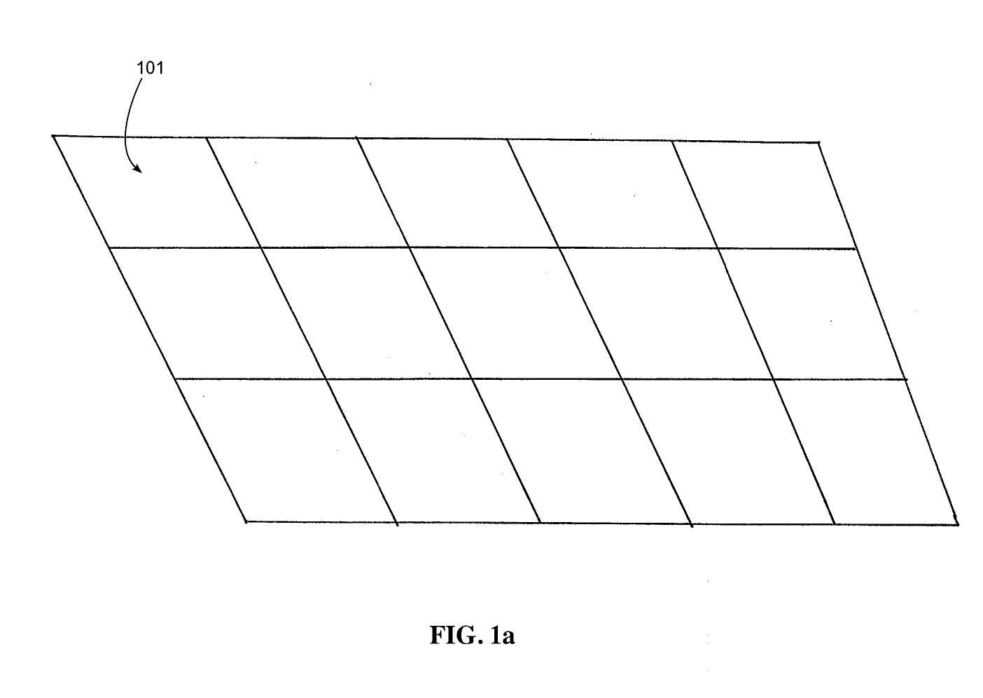

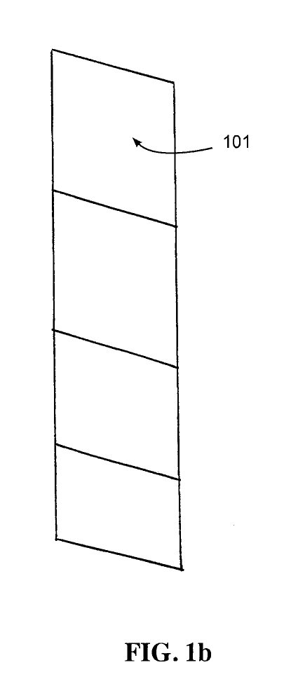

In reference now to FIG. 1a, depicted is a light source assembly including a plurality of light sources 101 arranged in a configuration (array) in accordance with some embodiments of the present disclosure. Such a configuration will be described below with reference to embodiments of the systems and methods of the present disclosure that may be adapted for use in an enclosed or self-contained plant growing environment, although as described above other uses of such an arrangement of light sources can be adapted without departing from the scope of the present invention.

The light source assembly may be arranged in a configuration such that, when incorporated into a plant growing environment, for example, one or more individual light sources may be positioned generally directly above one or more growing plants. In these embodiments, light produced by an individual light source will shine directly onto the corresponding growing plant situated therebeneath. Thus, such lighting configurations may provide “overhead” plant lighting. It will be appreciated that not all light sources in such a configuration or assembly need to have growing plants situated therebeneath, nor need all growing plants have a light source situated thereabove.

In alternative embodiments, as depicted, for example, in FIG. 1b, a light source assembly including a plurality of light sources 101 may be arranged in a substantially vertical configuration with reference to plants growing in an environment. In such embodiments, one or more light sources in the assembly may be positioned to provide lighting to lower portions of a growing plant, while one or more additional light sources may be positioned to provide lighting to upper portions of a growing plant. Thus, in such configurations, lighting may be provided at substantially all heights/levels of growing plants. Furthermore, additional light sources may be provided at levels above the height of a growing plant, such that as the plant grows over time, the additional light sources may then be in position to provide lighting for newly grown upper portions of the plant. Thus, such lighting configurations or assembly may provide “intracanopy” plant lighting.

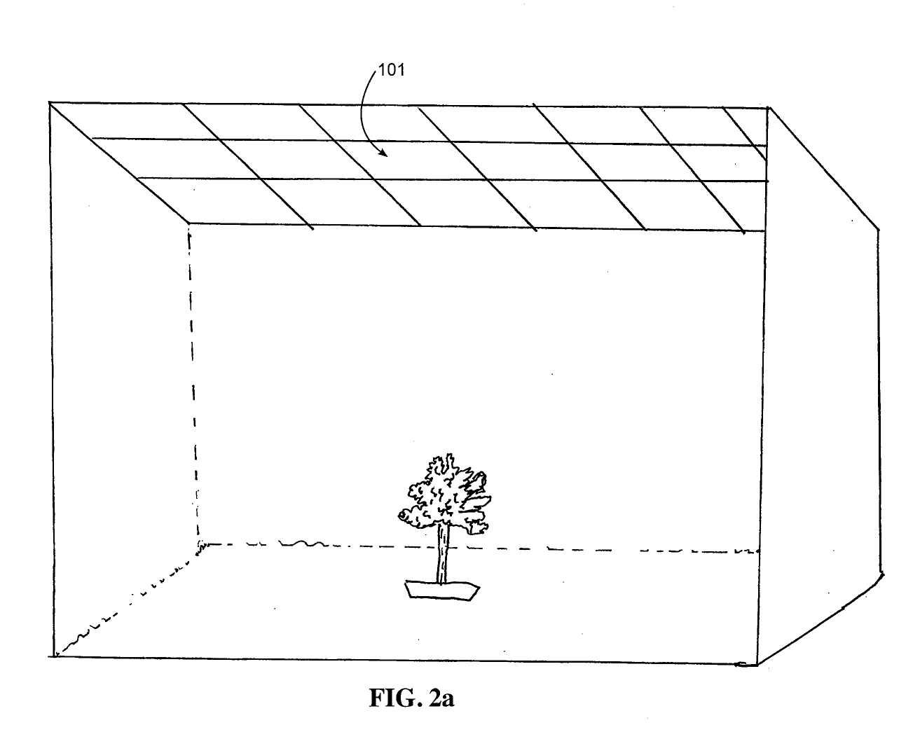

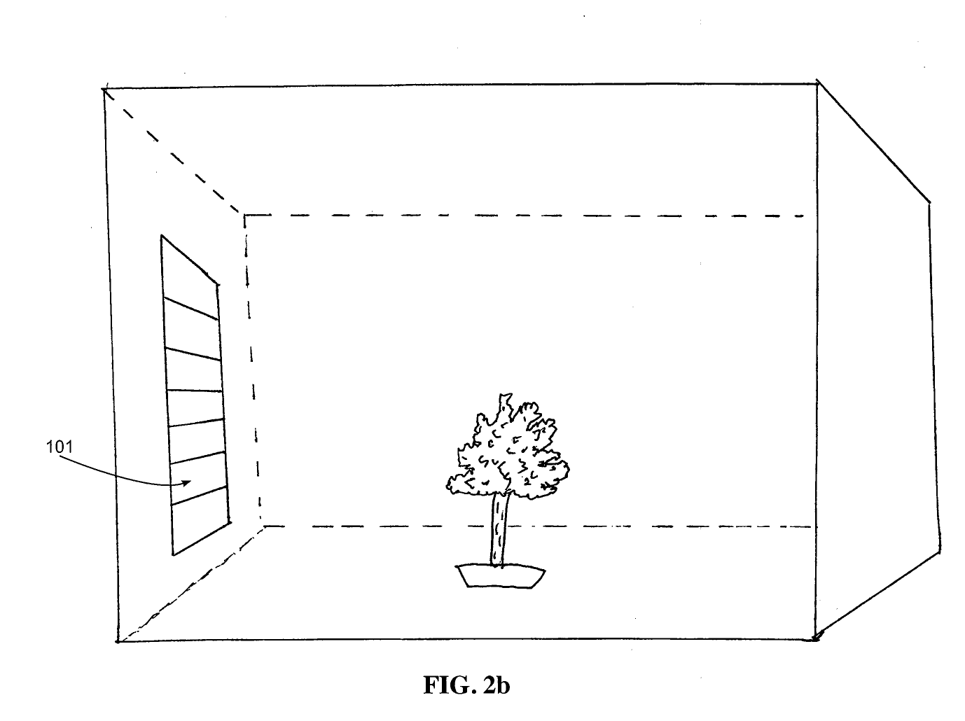

Therefore, in accordance with certain embodiments of the present disclosure, FIG. 2a depicts an overhead lighting arrangement adapted for use in an enclosed plant growing environment, and FIG. 2b depicts an intracanopy lighting arrangement adapted for use in an enclosed plant growing environment. It will also be appreciated that any combination of overhead or intracanopy lighting may be provided, consistent with the spirit and scope of the present disclosure.

It will be appreciated that the enclosed environment may be adapted for use with any type of plant. For example, in some embodiments, the plant growing environment may comprise a plurality of taller plants, which may include, for example, species of tobacco or tomato. These plants may be ordinary, naturally occurring plant species, or they may be plant species genetically engineered to produce pharmaceuticals or other desirable organic products. Such organic products may include spider silk dragline polypeptides, as disclosed in International Patent Application Number PCT/US2008/066448, filed Jun. 10, 2008 (International Patent Publication Number WO 2008/154547), which is hereby incorporated herein by reference in its entirety.

It will be appreciated that in embodiments where the target is not a plant, the enclosed environment may be suitably adapted to accommodate the target. For instance, lights and/or lighting arrangements may be positioned to affect and/or detect the target as desired.

In some embodiments, the light source assembly including the plurality of light sources may be controlled in all aspects by a light control system. In such a system, a user may set and/or change a parameter or parameters, or a parameter or parameters may be set and/or changed automatically by the light control system, or some combination thereof. The parameters may include, but are not limited to, for example, the intensity of the light source, the wavelength of the light provided, the length of time in operation, or other lighting parameters. Controllability of the control system may be provided through use of a computer system with software adapted to allow individual controllability of light sources through a graphical user interface (GUI) or other similar means. Such a GUI may include, for example, “sliders” on the screen corresponding to wavelength, intensity, or other parameters, or text boxes in which to enter numbers corresponding to wavelength, intensity, or other parameters. A graph on the screen may show the user how the desired spectrum/intensity, etc., will appear, for example. Alternately, the light control system may automatically set and/or change parameters according to, for example, pre-defined settings, or settings initially set by a user.

In still another embodiment, a user may be able to manually set and/or change a lighting parameter or parameters.

For example, the light control system, whether controlled automatically or by a user, may desire a particular spectral balance to be provided by the light source. This balance may be a pre-defined setting, or it may be a custom setting.

The spectral balance may be specified through a combination of individual light sources. In some embodiments, as discussed above, wherein LED light sources are provided, a light source may comprise individually controlled red, green, and blue (RGB) LEDs such that in combination, a specific spectral output may be provided. LEDs of other colors may also be provided. Thus, in an arrangement such as that depicted in FIG. 2a, for example, each light source above a growing plant, for example, may be an RGB combination LED light source, which may be specifically controlled to provide a lighting condition with a spectral composition, intensity, etc. for optimal growth of the growing plant therebelow. It will be appreciated that other combinations of light sources and controllability means may be provided in a plant growing environment consistent with the spirit and scope of the present disclosure.

In some embodiments, there may be associated with the light source assembly one or more sensors specially adapted to sense a particular condition associated with the target and that may be operably connectable to the light control system. Such conditions may include, among others, lighting, temperature and/or humidity, for example. In some embodiments, the lighting sensors may be adapted to sense, for example, but are not limited to, the spectral output of a light source or the intensity of a light source. Generally, LED intensity/spectral output may vary slowly over time in response to various factors such as room temperature, cooling efficiency, and length of use, for example. Thus, in these embodiments, the light control system may receive lighting condition feedback information from a sensor, and may adjust the light source accordingly. For example, if a light source drifts to a lower intensity, additional energy input or other suitable correctional measures may be applied by the control system to that light source to maintain the light source within the desired operational parameters, as selected by the user or the automated system. Furthermore, if a light source drifts to a different spectral output, the wavelength of the light source may be adjusted by the light control system (or the RGB output balance adjusted) to compensate for the drift.

In some embodiments, one or more sensors may be provided to detect humidity, gas composition, and/or temperature, for example. The humidity, gas composition and/or temperature sensors may be operably coupled to the light control system, such that the lights are controlled based on for example, the readings provided by the sensors. For example, if the temperature sensor indicates that the temperature in the enclosed environment is falling below an acceptable range, the light control system may either respond automatically to suitably adjust the lights in the enclosed environment or the light control system may alert a user that the temperature in the enclosed environment has fallen.

Some embodiments may further comprise an enclosed environment having walls and/or a floor coated with, or made from, an enhanced reflective substance. Feedback-control of light sources may be accomplished as a result of the characteristics of the reflectance of biological material (for example, growing plants). Such walls and/or floor may generally provide a tuned reflectance such that more accurate sensing (reflected) data may be sent to the light control system. Furthermore, such coating/material may eliminate the potential sensing of a “false positive” in connection with an empty location or plant height by preventing light reflected from a surface rather than biological tissue from impinging on the sensor.

In further embodiments, there may be associated with the plurality of light sources one or more additional sensors specially adapted to sense the presence/non-presence of a target, for example a growing plant, in a corresponding location within an environment, or alternatively, the stage of growth of a growing plant within a plant growing environment, for example.

For example, in embodiments represented by FIG. 2a (overhead lighting), a light source assembly 101 may have associated therewith a sensor capable of sensing the presence of a growing plant (or part thereof, i.e., leaves) therebelow, for example. In the event a growing plant is detected, the sensor may provide a corresponding signal to the light control system, and the light control system may automatically (or upon user command) provide an appropriate light output from the light source. In the event a growing plant is not detected, the sensor may provide a corresponding signal to the light control system, and the light control system may automatically (or upon user command) provide no light output from the light source assembly.

In other examples, in embodiments represented by FIG. 2b (intracanopy lighting), a light source assembly 101 may have associated therewith a sensor capable of sensing the presence of a growing plant at a height corresponding to the height of the light source assembly (thus representing that a plant has reached a particular stage of maturity). Corresponding signals may then be sent from the sensor to the light control system in a manner as described above with respect to FIG. 2a, resulting in light being output/not being output from that particular light source, depending on whether a plant at that height has been detected (i.e., whether the growing plant has reached the corresponding stage of maturity).

It will also be appreciated that a single type of sensor may be configured to sense both a lighting condition and the presence or non-presence of growing plants, for example. Sensors suitable for use with embodiments of the present disclosure include, for example, photodiodes. In embodiments where the sensors are tuned to receive only a single color of interest, for example, red in an RGB system, other colors (blue and green) may be turned off during sensing. Alternatively, multiple sensors may be provided for multiple colors of interest (with appropriate optical filters to separate out the other colors), or sensors capable of sensing more than one color may be provided. In some embodiments, the sensors may be provided near one or more light sources. In other embodiments, sensors may be integrated within the light sources. Alternatively, sensors may be provided in other locations throughout the enclosed environment. Connection between the sensors and the control system may be provided by direct (wired) or wireless means.

In some embodiments, the uniformity of the light provided by a light array of the integrated lighting system of the present disclosure may be controlled by the computerized control system. For instance, for a given light array or assembly in an integrated lighting system of the present disclosure, a user may provide desired values for a particular parameter or parameters. A user may accomplish this by using computer software associated with the system as was described above. Alternately, software may already include predefined parameters for specific uses of embodiments of the present disclosure. Parameters may include, for example, but are not limited to, the location of the plant, for instance, in relation to other arrays or walls, or the location of the array itself in relation to other arrays or walls. The light control system, including in some embodiments associated software, may adjust the individual lighting units, or engines, within the array based upon the information provided by the user and/or the software related to the parameters of interest and/or the information received from any or all of the sensors that may be included in the system. In some embodiments, the adjustments made by the light control system may create a uniform level of lighting across the surface of the target, for instance. It will be recognized, however, that a uniform level of lighting is only one possible result that is achievable according to this embodiment of the present disclosure. Other desirable results may include varied lighting across different areas of the target, or lighting that changes over time, for example.

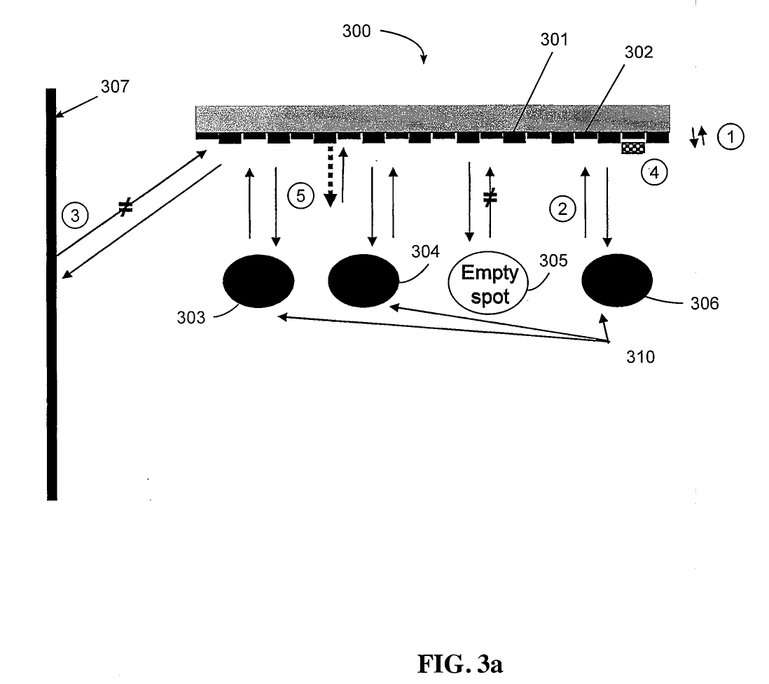

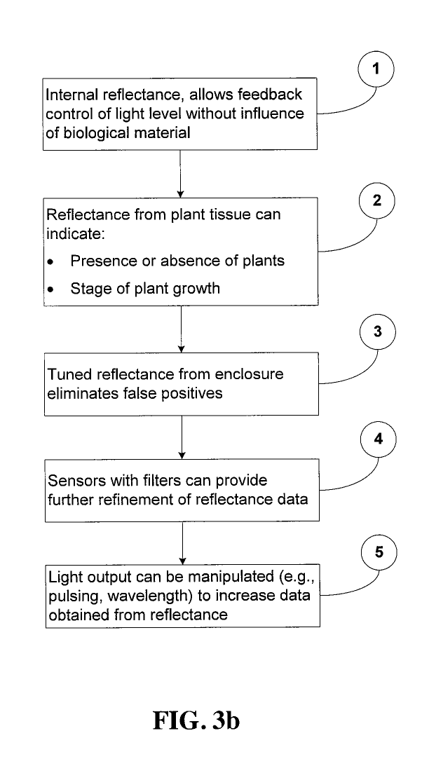

In reference now to FIG. 3a, an embodiment of a method and system for use within a plant growing environment 300 is shown which comprises a light source assembly including a plurality of overhead lighting sources 301, and a plurality of sensors 302 which may be configured to sense both a lighting condition and the presence/non-presence of a growing plant in a corresponding location within the environment 300. As noted above, while this method is described with respect to a plant growing environment, it will be recognized that the method is not limited to uses employing a plant growing environment, but may apply to other embodiments of the present disclosure as well. Positions 303, 304, and 306 represent growing plants at difference stages of growth which may be sensed by a sensor 302, while position 305 represents an empty position which may also be sensed by a sensor 302. Wall 307 has coated thereon a material which provides finely tuned sensing for a lighting condition by a sensor 302.

As shown in FIG. 3b and with reference to FIG. 3a, an example method in accordance with some embodiments is depicted comprising procedures which may be implemented in whole or in part by the light control system as operated automatically or by a user. As depicted at procedure 1, internal reflectance as sensed by a sensor 302 allows feedback control of light levels, or other lighting conditions and parameters, without the influence of biological material such as growing plants within the environment 300. At procedure 2, reflectance from plant tissue as sensed by a sensor may indicate presence or non-presence of growing plants at a position in embodiments employing overhead lighting, for example, or it may indicate height and stage of plant growth in intracanopy lighting embodiments. At procedure 3, tuned reflectance as enabled by the coating (or material) on wall 307 and/or on the floor (not depicted) of the environment 300 may enable the elimination of “false positive” plant sensing. Furthermore, as depicted at procedure 4, tuned reflectance as enabled by the coating (or material) on wall 307 and/or the floor (not depicted) of the environment 300 may enable filters provided with the sensors 302 to further and more accurately refine sensed reflectance data of a lighting condition. At procedure 5, it is depicted that lighting output from one or more of the plurality of light sources may be manipulated, for example, by pulsing or changing the output wavelength, in order to increase the reflectance data received in connection with sensing a lighting condition or sensing the presence or non-presence of a growing plant, for example, at a particular position or at a particular height (e.g. stage of maturity).

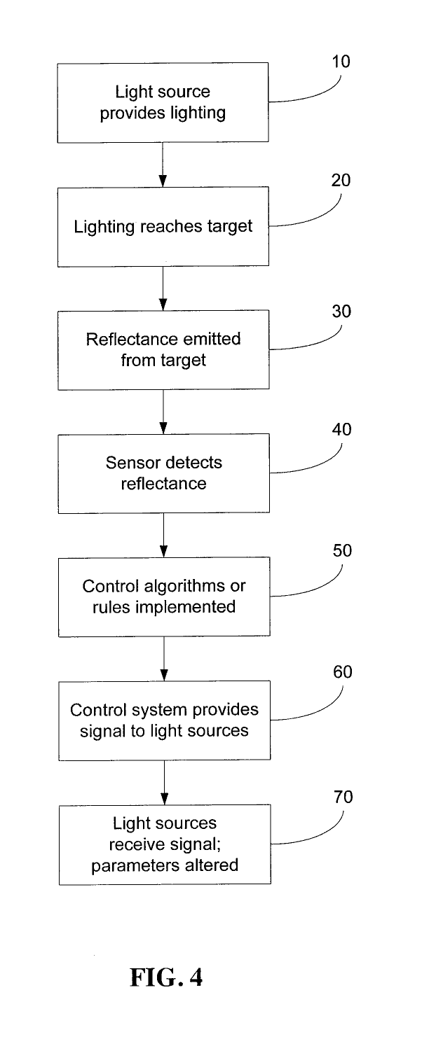

In reference now to FIG. 4, an example method in accordance with one embodiment is depicted comprising procedures which may be implemented in whole or in part by the light control system as operated automatically or by a user. At procedure 10, lighting is provided by a light source assembly including one or more light sources. At procedure 20, the lighting reaches a target which may be a growing plant or a wall or a floor of an enclosed plant growing environment, for example. At procedure 30, a reflectance is emitted from the target reached by the lighting. At procedure 40, one or more sensors detect the reflectance. At procedure 50, control algorithms or rules may be implemented by the light control system automatically or by a user in response to the reflectance sensed by the sensor. Such control algorithms or rules may comprise, as discussed above, changing the intensity of one or more light sources, changing the wavelength output of one or more light sources, turning on/off one or more light sources, or changing the spectral composition of one or more combination light sources. At procedure 60, the control system provides a signal to the appropriate light sources in accordance with the control algorithms or rules. Finally, at procedure 70, the light sources receive the signal and the lighting output parameters are altered accordingly.

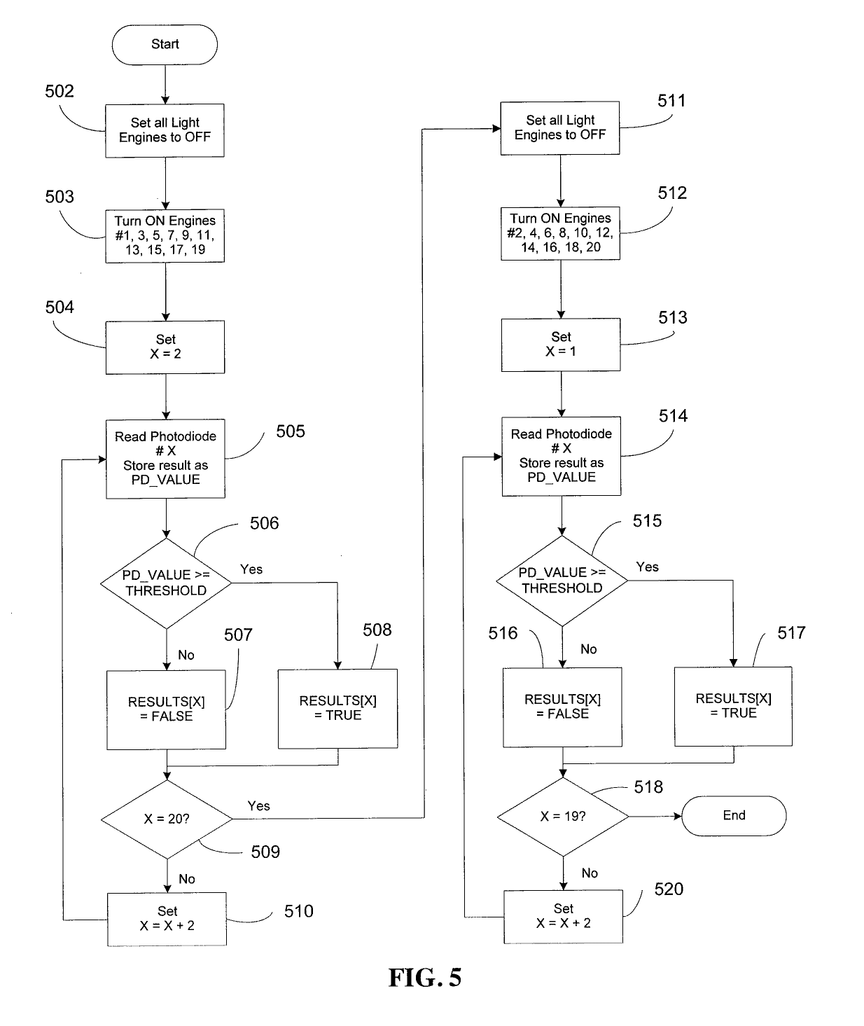

In reference now to FIG. 5, an exemplary method in accordance with one embodiment is depicted as an algorithm comprising steps which may be implemented in whole or in part by the light control system as operated automatically or by a user. Such an algorithm may be implemented in, for example, embodiments wherein some lights are turned off during sensing (as discussed above). In this example algorithm, 20 individual LEDs are represented, with their associated sensors, as “light engines.” At procedure 502, all light engines are set to “off” At procedure 503, odd numbered light engines are turned “on.” Odd numbered light engines may represent, for example, LEDs of a particular color, or other lighting condition. At procedure 504, a variable “X” is set to equal the lowest even numbered light engine, for example, 2. Then, at procedure 505 a value of a lighting condition is read by sensor “X” (in this example, photodiodes are implemented as sensors), and the associated numerical value of the sensed lighting condition is stored in a variable “PD_VALUE.” At procedure 506, the PD_VALUE is compared to a variable represented as “THRESHOLD.” THRESHOLD may represent a set numerical value of a desired lighting condition, determined automatically or by a user, as discussed above. If PD_VALUE is greater than or equal to THRESHOLD, then a boolean variable “RESULT(X)” is set as “TRUE” as depicted at procedure 508. Alternatively, if PD_VALUE is not greater than or equal to THRESHOLD, then the boolean variable RESULT(X) is set as “FALSE” as depicted at procedure 507. At procedure 509, it is determined whether X is equal to the highest even numbered light engine, for example, 20. If not (for example, in this description, where X was set at 2), then X is increased in value by 2 at procedure 510, and the algorithm continues with the new X value at procedure 505. Alternatively, if X has the value of the last even numbered light engine, then all light engines are once again turned off, as shown at procedure 511. Then, at procedure 512, the even numbered light engines are turned on. Even numbered light engines may represent, for example, LEDs of a particular color, or other lighting condition. At procedure 513, the variable X is set equal to the lowest odd numbered light engine, for example, 1. At this point, procedures 514-520 are implemented in a manner analogous to procedures 505-510, as described in detail above, with the one exception that, if at procedure 518 (analogous to procedure 509) X does have a value equal to the highest odd numbered light engine (for example, 19), the algorithm is ended, rather than turning all light engines off (as would occur at procedure 511).

Some embodiments of the present disclosure may provide a means to detect and/or modify other environmental conditions within an environment, for example, but not limited to a plant growing environment. For example, a thermostat may be provided in connection with a heating and/or cooling element or similar apparatus to enable temperature control. A psychrometer may be provided in connection with a humidifier or similar apparatus to enable humidity control. Furthermore, a gas composition sensor may be provided with a reserve of O₂ or CO₂ (or other atmospheric gasses) in order to enable control of the atmospheric gas composition within the plant growing environment. Other sensing means and corresponding apparatuses, provided in connection with an enclosed environment, are also considered to be within the spirit and scope of the present disclosure.

In connection with embodiments of the present disclosure implementing a control system, software may be provided to automatically control some or all of the controllable factors. For example, software may be provided with data related to optimal lighting and other environmental conditions for particular targets, for example, various species of plants in some embodiments. The software may then automatically configure one or more light sources (or other environmental conditions) at locations where such plant species may be located. Such software may be operably connectable through the control system to one or more sensors to ensure appropriate parameters are being output, and to correct for drift or other undesirable changes in the controlled parameters. Alternatively, such parameters may be entered into the control system and monitored/controlled manually by a user.

Furthermore, it will be appreciated by those skilled in the art that additional materials may be necessary for the operation of an enclosed environment, for example in embodiments applying the integrated lighting system of the present invention to plant growing environments, some of the additional materials may be, for instance, electricity, soil, water, nutrients, fertilizer, among others. Such known requirements for plant growth are also to be considered inherently disclosed herein. Similarly such known requirements for embodiments other than plant growing environments are to be considered inherently disclosed herein.

Although the present disclosure has been described with reference to various embodiments, persons skilled in the art will recognize that changes may be made in form and detail without departing from the spirit and scope of the disclosure.

What is claimed is:

1. An apparatus for affecting change in a target by using an integrated lighting system, the apparatus comprising:
a light source assembly including a plurality of LEDs having one or more parameters and being configured to provide lighting, wherein each of the plurality of LEDs are individually integrated in the assembly;
a sensor configured to detect at least one lighting condition from the target and/or the light source assembly, wherein the target is an object, including an organism, and one of the lighting conditions detected from the target is whether or not the target is present; and
a control system operably connectable to the light source assembly and the sensor, wherein the control system intelligently controls the amount and type of light provided to the target by controlling each of the plurality of LEDs and the sensor individually;
wherein when the sensor detects the lighting condition from the target and/or the light source assembly, the sensor sends a signal representing a detected lighting condition to the control system;
wherein upon receiving the signal from the sensor, the control system compares the detected lighting condition to a desired lighting condition; and
wherein if the detected lighting condition is different from the desired lighting condition, the control system adjusts the one or more parameters of the light source assembly.

2. The apparatus of claim 1, wherein the light source assembly further comprises at least one non-LED light source.

3. The apparatus of claim 1, wherein the light source assembly is arranged within an enclosed environment in an overhead configuration.

4. The apparatus of claim 1, wherein the light source assembly is arranged within an enclosed environment in an intracanopy configuration.

5. The apparatus of claim 1, wherein the enclosed environment includes a side wall and a floor which are made of or coated with an enhanced reflecting material.

6. The apparatus of claim 1, further comprising sensors configured for detecting temperature, humidity, or gas composition within an enclosed environment.

7. The apparatus of claim 1, wherein the desired lighting condition is determined by a user, which is entered into the control system.

8. The apparatus of claim 1, wherein the desired lighting condition is determined automatically by the control system.

9. The apparatus of claim 1, wherein the target is a biological organism.

10. The apparatus of claim 1, wherein the target is at least one plant in a plant growing environment and the sensor is configured to detect the stage of growth of the plant.

11. A method for affecting change in a target using an integrated lighting system, the method comprising:
providing a light source assembly including a plurality of LEDs having one or more parameters and being configured to provide lighting, wherein each of the plurality of LEDs are individually integrated in the light source assembly;
providing a sensor configured to detect at least one lighting condition from the environment and/or the light source assembly, and wherein one of the lighting conditions detected from the target is whether or not the target is present; and
providing a control system operably connectable to the light source assembly and the sensor, wherein the control system intelligently controls the amount and type of light provided to the target by controlling each LED and each sensor individually;
wherein when the sensor detects the lighting condition from the target and/or the light source assembly, the sensor sends a signal representing a detected lighting condition to the control system;
wherein upon receiving the signal from the sensor, the control system compares the detected lighting condition to a desired lighting condition; and
wherein if the detected lighting condition is different from the desired lighting condition, the control system adjusts the one or more parameters of the light source assembly.

12. The method of claim 11, wherein the light source assembly further comprises a non-LED light source.

13. The method of claim 11, wherein at least one of the plurality of LEDs has an output wavelength different from the output wavelength of the other LEDs.

14. The method of claim 11, wherein the light source assembly is arranged within an environment in an overhead configuration.

15. The method of claim 11, wherein the light source assembly is arranged within an environment in an intracanopy configuration.

16. The method of claim 11, wherein the environment includes a side wall and a floor which are made of or coated with an enhanced reflecting material.

17. The method of claim 11, further comprising sensors configured for detecting temperature, humidity, or gas composition within an enclosed environment.

18. The method of claim 11, wherein the desired lighting condition is determined by a user, which is entered into the control system.

19. The method of claim 11, wherein the desired lighting condition is determined automatically by the control system.

20. The method of claim 11, wherein the sensor is further configured to detect the presence of a plant.
